(19) United States
(12) Patent Application Publication
(10) Pub. No.: US 2013/0163425 A1
(43) Pub. Date: Jun. 27, 2013

(54) SYSTEM AND METHOD FOR MANAGING BEACON TRAFFIC WITHIN A NETWORK SYSTEM

(71) Applicants: Sterling HUGHES, Oakland, CA (US); Peter HUNT, Sunnyvale, CA (US); Jana VAN GREUNEN, Woodside, CA (US); Chris COLLINS, San Jose, CA (US)

(72) Inventors: Sterling HUGHES, Oakland, CA (US); Peter HUNT, Sunnyvale, CA (US); Jana VAN GREUNEN, Woodside, CA (US); Chris COLLINS, San Jose, CA (US)

(21) Appl. No.: 13/334,035

(22) Filed: Dec. 21, 2011

(51) Int. Cl. H04W 28/10

(52) U.S. Cl. 370/235

(57) ABSTRACT

One embodiment of the present disclosure sets forth an improved way for a node to manage beacon traffic. Specifically, the node determines that a new message is to be transmitted to one or more neighboring nodes. The node assigns a value to the message based on certain message characteristics. The node utilizes this message value to determine whether to unicast the message to each one of the subscribing nodes or to add the message to the node's beacon. If adding the message to the node's beacon results in a beacon length that is above a desired limit, then the node may add a second beacon to carry the new message. One advantage of this approach is that beacon transmission times are kept low in order to reduce the likelihood that the beacon encounters interference from artificial or natural sources, including interference from beacons transmitted by other nodes.

### BACKGROUND OF THE INVENTION

1. Field of the Invention

Embodiments of the present invention relate generally to wireless digital communication systems and methods and, more specifically, to a system and method for managing beacon traffic within a network system.

2. Description of the Related Art

A conventional wireless mesh network includes a plurality of nodes, each incorporating a network interface. A given node may transmit payload data to one or more other nodes via the network interface. The node may originate the payload data or forward the payload data on behalf of a different node. Similarly, a given node may receive the payload data from a different node to be processed or forwarded by the node. The wireless mesh network may include an arbitrary number of nodes and may include certain access points, configured to bridge data communications within the mesh network to a related service system, such as a wire line or optical communications network.

Nodes within the wireless mesh network may wish to communicate one or more messages to some or all nodes within a transmission range. For example, a node may perform neighbor discovery (that is, locate other nearby nodes) or advertise routing information to nearby nodes by communicating with these nearby nodes. The node may send a “beacon” to communicate to more than one node with a single transmission. A beacon is a transmission, containing one or more messages, which may be generated by one node and received by some or all of the nodes within a transmission range. All or fewer than all of the nodes in a network may be capable of beaconing. Beacons may be periodically transmitted to other nodes on a pre-determined channel sequence. Any node that knows the beacon channel sequence and timing may listen to the beacon transmission from a transmitting node. Over time, a node may increase the number of messages to transmit to neighboring nodes. This condition may occur, for example, as the node joins more networks. As the number of messages increases, the size of the beacon increases accordingly.

One disadvantage of this approach is that a beacon is more prone to being lost as the size of the beacon increases. Various artificial or natural phenomena may interfere with the beacon, causing partial or total loss of the beacon. These phenomena may include communications signals from other transmitters outside of the wireless mesh network or natural electromagnetic interference. As the size of the beacon increases, so does the time required to transmit the beacon to neighboring nodes. Because a large beacon requires a longer transmission time, the beacon is subject to interference for a longer period of time. If this interference causes the beacon to not be received by neighboring nodes, then the wireless mesh network may experience performance degradation and loss of communications stability. Another disadvantage of this approach is that a beacon has a greater likelihood of encountering interference from another node's transmission as the size of the beacon increases. Multiple nodes may transmit beacons at regular intervals over the same communications channel. When two nodes transmit a beacon at or near the same time, the beacons may interfere with each other, causing loss of one or both beacons. As described above, as the beacon increases in size, the transmission time also increases, as does the beacon's vulnerability to interference from other transmission sources, even where the transmission source is another node's transmission of a beacon on the same communications channel.

As the foregoing illustrates, what is needed in the art is a more flexible technique for managing beacon traffic within a network system.

### SUMMARY OF THE INVENTION

One embodiment of the present invention sets forth a method for managing beacon traffic within a network system. A node identifies a message to be transmitted to at least one neighboring node. The node computes a message value related to one or more characteristics associated with the message. The node then determines a mode in which to transmit the message based on the message value. The node transmits the message in a beacon mode where the message value exceeds a threshold. The node transmits the message in a unicast mode where the message value does not exceed a first threshold.

Other embodiments include, without limitation, a computer-readable medium that includes instructions that enable a processing unit to implement one or more aspects of the disclosed methods as well as a system configured to implement one or more aspects of the disclosed methods.

One advantage of this approach is that beacon transmission times are kept low in order to reduce the likelihood that the beacon encounters interference from artificial or natural sources, including interference from beacons transmitted by other nodes.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a network system, according to one embodiment of the invention;

FIG. 2 illustrates a computer system configured to implement one or more aspects of the present invention; and

FIG. 3 is a flow diagram of method steps for managing beacon traffic within a network system, according to one embodiment of the present invention; and

FIG. 4 is a flow diagram of method steps for transmitting beacon and unicast traffic within a network system, according to one embodiment of the present invention.

### DETAILED DESCRIPTION

In the following description, numerous specific details are set forth to provide a more thorough understanding of the present invention. However, it will be apparent to one of skill in the art that the present invention may be practiced without one or more of these specific details. In other instances, well-known features have not been described in order to avoid obscuring the present invention.

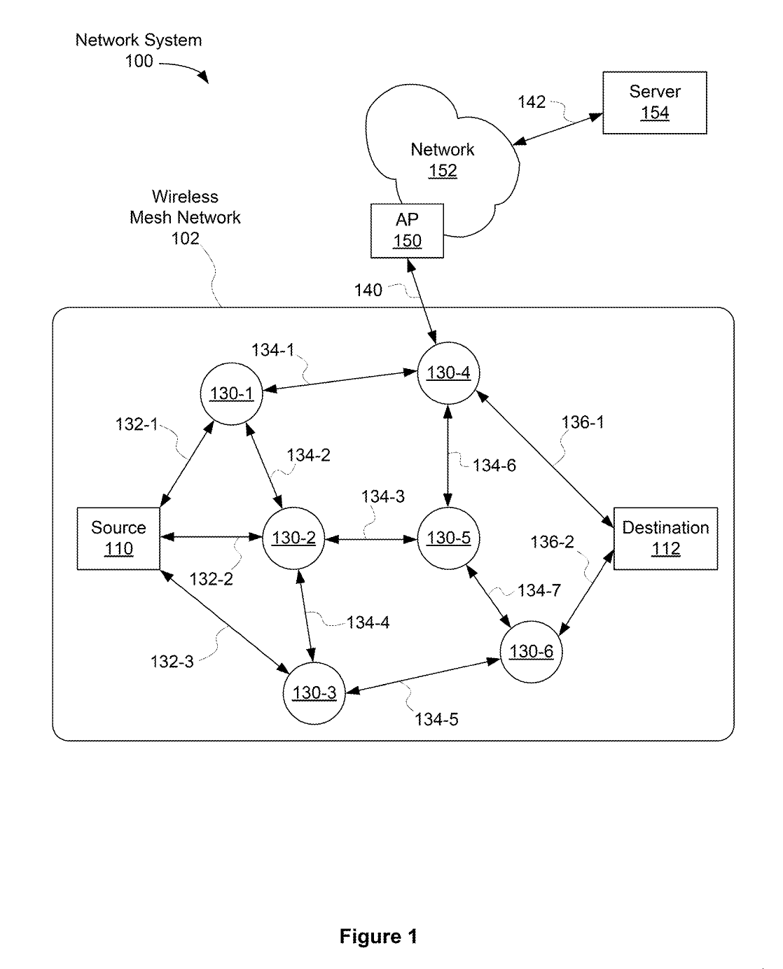

FIG. 1 illustrates a network system 100, according to one embodiment of the invention. The network system 100 comprises a wireless mesh network 102, which may include a source node 110, intermediate nodes 130 and destination node 112. The source node 110 is able to communicate with certain intermediate nodes 130 via communication links 132. The intermediate nodes 130 communicate among themselves via communication links 134. The intermediate nodes 130 communicate with the destination node 112 via communication links 136. The network system 100 may also include an access point 150, a network 152, and a server 154.

A discovery protocol may be implemented to determine node adjacency to one or more adjacent nodes. For example, intermediate node 130-2 may execute the discovery protocol to determine that nodes 110, 130-1, 130-3, and 130-5 are adjacent to node 130-2. Furthermore, this node adjacency indicates that communication links 132-2, 134-2, 134-4 and 134-3 may be established between the nodes 110, 130-1, 130-3, and 130-5, respectively. Any technically feasible discovery protocol may be implemented without departing the scope and spirit of embodiments of the present invention.

Once adjacency is established between the source node 110 and at least one intermediate node 130, the source node 110 may generate payload data for delivery to the destination node 112, assuming a path is available. The payload data may comprise an Internet protocol (IP) packet, an Ethernet frame, or any other technically feasible unit of data. Similarly, any technically feasible addressing and forwarding techniques may be implemented to facilitate delivery of the payload data from the source node 110 to the destination node 112. For example, the payload data may include a header field configured to include a destination address, such as an IP address or Ethernet media access control (MAC) address. Each intermediate node 130 may be configured to forward the payload data based on the destination address. Alternatively, the payload data may include a header field configured to include at least one switch label to define a predetermined path from the source node 110 to the destination node 112. A forwarding database may be maintained by each intermediate node 130 that indicates which communication link 132, 134, 136 should be used and in what priority to transmit the payload data for delivery to the destination node 112. The forwarding database may represent multiple paths to the destination address each of the multiple paths may include one or more cost values. Any technically feasible type of cost value may characterize a link or a path within the network system 100. In one embodiment, each node within the wireless mesh network 102 implements substantially identical functionality and each node may act as a source node, destination node or intermediate node.

As shown, the access point 150 is configured to communicate with at least one node within the wireless mesh network 102, such as intermediate node 130-4. Communication may include transmission of payload data, timing data, or any other technically relevant data between the access point 150 and the at least one node within the wireless mesh network 102. For example, communications link 140 may be established between the access point 150 and intermediate node 130-4 to facilitate transmission of payload data between wireless mesh network 102 and network 152. The network 152 may be coupled to the server 154 via communications link 142. The access point 150 is coupled to the network 152, which may comprise any wired, optical, wireless, or hybrid network configured to transmit payload data between the access point 150 and the server 154. In one embodiment, the server 154 represents a destination for payload data originating within the wireless mesh network 102 and a source of payload data destined for one or more nodes within the wireless mesh network 102. In one embodiment, the server 154 executes an application for interacting with nodes within the wireless mesh network 102. For example, nodes within the wireless mesh network 102 may perform measurements to generate measurement data, such as power consumption data. The server 154 may execute an application to collect the measurement data and report the measurement data. In one embodiment, the server 154 queries nodes within the wireless mesh network 102 for certain data. Each queried node replies with requested data, such as consumption data, system status and health data, and so forth. In an alternative embodiment, each node within the wireless mesh network 102 autonomously reports certain data, which is collected by the server 154 as the data becomes available via autonomous reporting.

A source node 110 may identify one or more messages to send to some or all neighboring nodes 130. The messages may be of various message types including, without limitation, messages to perform neighbor discovery (that is, locate other nearby nodes) or messages containing information for other nodes 130 such as routing advertisements, configuration data, or timing information. Various messages may be of different lengths determined, for example, by the message type. Further, each message from source node 110 may be requested by some or all neighboring nodes 130. For example, all neighbor nodes may request a particular timing message while only two neighboring nodes 130 may request a particular configuration message. Nodes 130 typically request specific messages via a subscription mechanism or via any technically feasible mechanism as is known in the art.

The source node 110 may transmit a message in a unicast mode or in a beacon mode. When a message is transmitted in unicast mode, the source node 110 transmits a separate message to each one of the neighboring nodes 130 that has requested the message. When a message is transmitted in beacon mode, the source node 110 transmits a beacon including the message to all neighboring nodes 130 that are monitoring the source node's 110 beacon transmissions. The source node 110 determines which messages to unicast and which to beacon by assigning a message value to each message. The message value is a function of various parameters including, without limitation, the message type, the length of the message, and the number of nodes 130 requesting the message. For example, a message's value may increase as the number of requesting nodes 130 increases. In another example, a message's value may increase as the size of the message increases. In another example, certain message types may have higher value than other message types.

Higher value messages are allocated for beacon transmission while lower value messages are allocated for unicast transmission. In this way, a message may have a higher value when a large number of neighbor nodes 130 request the message, when the message length is greater, or when the message is of a high priority message type. Transmitting such a message in a beacon may result in greater reduction in network traffic. A message may have a lower value when a small number of neighbor nodes 130 request the message, when the message length is smaller, or when the message is of a low priority message type. Such a message has less potential to reduce network traffic, and the source node 130 may elect to transmit the message in unicast mode, sending a point-to-point message to each neighbor node 130 that has requested the message.

When a message has been allocated to be transmitted via beacon mode, the source node 110 assigns the message to a beacon. Initially, the source node 110 may include only one beacon. However, as the number of messages in the beacon increases, the source node 110 may determine that the beacon size has reached a threshold length and the beacon may not contain additional messages. The threshold length for a beacon may be determined by various factors including, without limitation, the period of time required to transmit the beacon, the current communications conditions, or a system limitation within the source node 110. If the message may be included in the current beacon without exceeding the threshold length, then the source node 110 adds the message to the current beacon. If adding the message to the current beacon results in a beacon length that exceeds the threshold, then the source node 110 creates a second beacon and assigns the message to the second beacon.

The source node 110 periodically transmits unicast messages and beacons. At any given transmission interval, the source node 110 typically transmits one or more unicast messages and one beacon, although any quantity of unicast messages and beacons may be transmitted within a transmission period. The source node 110 transmits unicast messages scheduled for the current transmission period. The source node 110 also transmits the beacon. If the source node 110 has more than one beacon, then the source node 110 selects a beacon for the next transmission period using a round-robin method or any other technically feasible approach. The source node 110 may then adjust the beacon transmission rate. As the number of beacons increases or decreases, the source node 110 may choose to increase or decrease the rate at which beacons are transmitted. The source node 110 may choose a minimum time period during which the beacon transmission rate does not change. If this minimum time period has expired, then the source node determines whether to increase or decrease the beacon transmission rate based on the number of beacons to transmit.

In one example, a source node 110 desires to transmit routing advertisements to neighboring nodes 130 that may be interested in one or more of the routes being advertised by the source node 110. A route advertisement is a message that indicates the source node 110 is available for a specific routing path in the network system 100. In this example, all messages could be of the same message type, namely a routing advertisement. Further, the routing advertisements could be all of the same length. As such, the message value could be based only on the number of neighboring nodes 130 interested in the specific routing advertisement.

The source node 110 could allocate a routing advertisement to be transmitted via unicast or beacon using a variety of approaches. For example, the source node 110 could advertise a route when the source node 110 first joins a network by sending a unicast message to all neighboring nodes 130. Each neighboring node 130 could acknowledge the routing advertisement by sending an acknowledgement message back to the source node 110. Neighboring nodes 130 that are interested in subscribing to the routing path associated with the routing advertisement could include a subscription request within the acknowledgment message. If the source node 110 determines that more than a threshold number of neighboring nodes are interested in the routing path, then the source node 110 allocates the routing advertisement for beacon transmission. Otherwise, the routing advertisement continues to be transmitted in unicast mode. The source node 110 could periodically schedule all messages for unicast mode, forcing beacons to be recreated, in order to accommodate changes in network configuration over time.

In another example, neighboring nodes 130 could notify the source node 110 regarding which routes the neighboring nodes 130 are interested in joining. The source node 110 utilizes these notifications to determine how many neighboring nodes are interested in each route. The source node 110 then could schedule each routing advertisement for unicast or beacon mode based on the number of neighboring nodes 130 interested in each route.

In another example, the source node 110 could insert a routing advertisement in a beacon when the source node 110 first joins a network. The source node 110 could monitor how many neighboring nodes 130 are using the routing path associated with the routing advertisement. After monitoring the routing path for a specified amount of time, the source node 110 could allocate the routing advertisement for unicast mode where less than a threshold amount of neighboring nodes 130 are using the associated routing path. Otherwise, the source node 110 could keep the routing advertisement in the beacon. The source node 110 could periodically repeat the full-advertisement and monitoring technique in order to accommodate changes in network configuration over time.

In any of these examples, the source node 110 may increase or decrease the number of beacons and may adjust the beacon transmission rate accordingly.

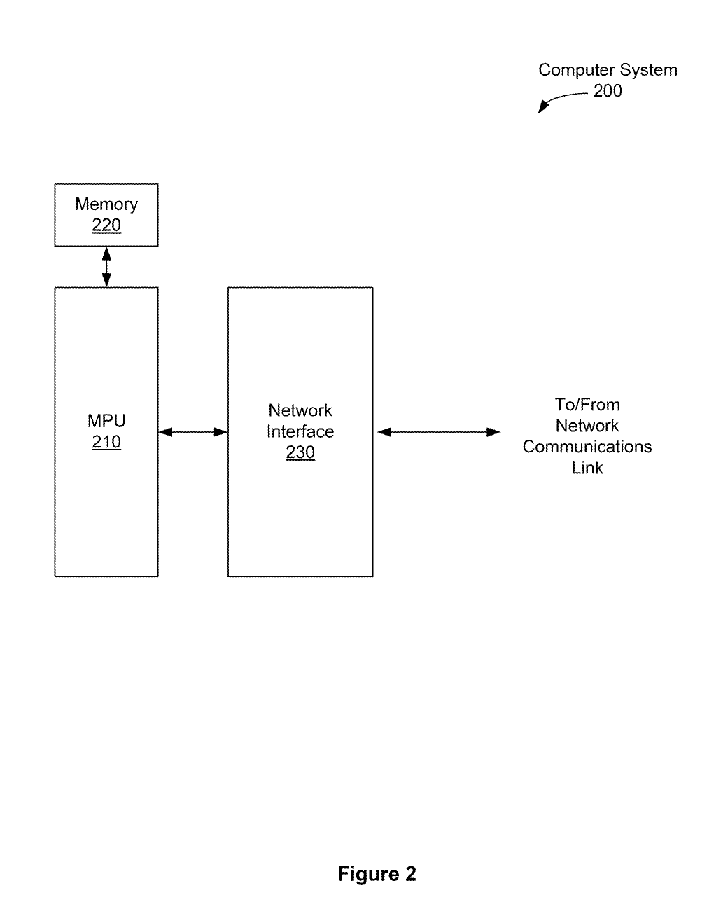

FIG. 2 illustrates a computer system 200 configured to implement one or more aspects of the present invention. Each node 110, 112, 130 and each access point 150 within the wireless mesh network 102 of FIG. 1 typically includes at least one instance of the computer system 200. As shown, the computer system 200 may include, without limitation, a microprocessor unit (MPU) 210, a memory 220, and a network interface 230. In one embodiment, the MPU 210 implements procedures for processing IP packets transmitted or received as payload data by the computer system 200. The procedures for processing the IP packets may include, without limitation, wireless routing, encryption, authentication, protocol translation, and routing between and among different wireless and wired network ports. A memory 220 may be coupled to the MPU 210 for local program and data storage.

A network interface 230 may be coupled to implement, without limitation, one or more the communication links 132, 134, 136, 140. The network interface 230 may utilize any technically feasible network protocol including, without limitation, a wide-area network (WAN) or a local-area network (LAN). Moreover, multiple network types may be implemented within a given network interface 230. For example, communications between two nodes 130 or between a node 130 and the corresponding access point 150 may be via a radio-frequency local-area network (RF LAN), while communications between access points 150 and the network 152 may be via a WAN such as a general packet radio service (GPRS) network. The network system may be of any technically feasible type or configuration. For example, the network system may be, without limitation, a distribution automation (DA) network or an advanced metering infrastructure (AMI) network.

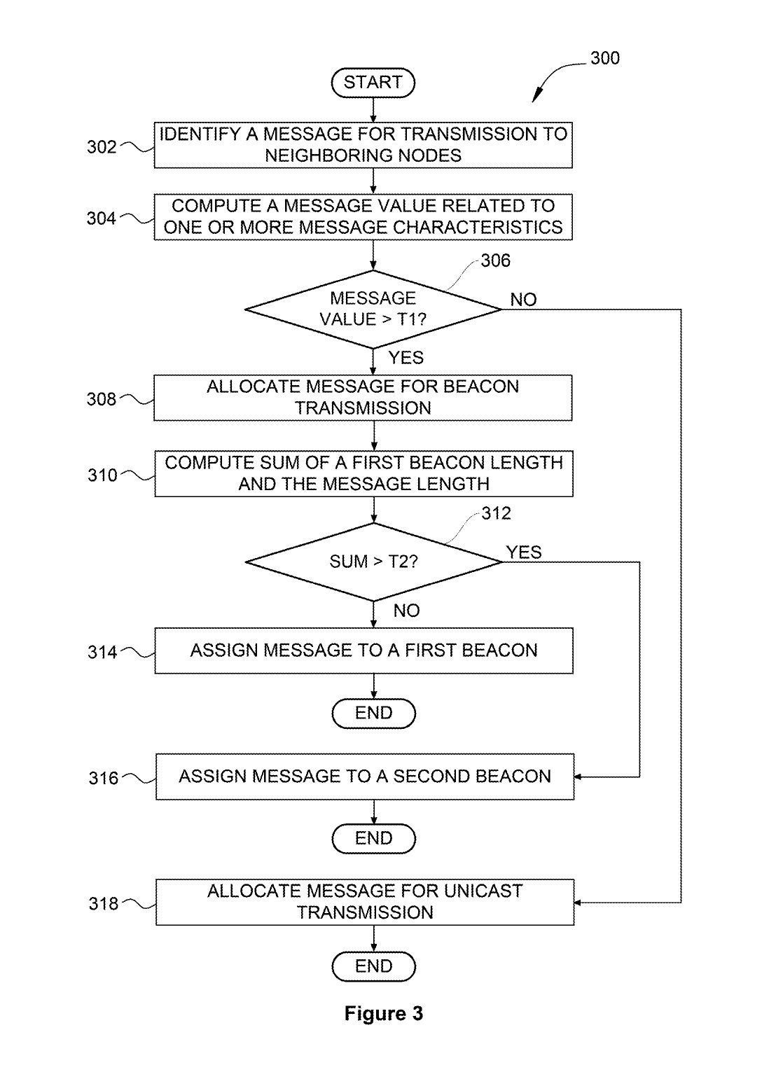

FIG. 3 is a flow diagram of method steps 300 for managing beacon traffic within a network system, according to one embodiment of the present invention. Although the method steps 300 are described in conjunction with the systems of FIGS. 1-2, persons of ordinary skill in the art will understand that any system configured to perform the method steps 300, in any order, is within the scope of the present invention.

The method 300 begins at step 302, where the source node 110 identifies a message which is to be transmitted to one or more neighboring nodes 130. The message may be for the purpose of locating other nearby nodes 130 or advertising routing information to these neighboring nodes 130. At step 304, the source node 110 computes a message value related to one or more characteristics of the message. For example, the message value may be affected by, without limitation, the message type, the message length, and the number of nodes 130 desiring to subscribe to the message. At step 306, the source node 110 determines whether the message value exceeds some threshold T1, where T1 represents a value above which transmitting the message in a beacon as advantageous relative to unicast transmission. If the message value does not exceed the threshold T1, then the source node 110 then the method 300 proceeds to step 318, where the source node 110 allocates the message for unicast transmission. The method 300 then terminates. Returning to step 306, if the message value exceeds the threshold T1, then the method 300 proceeds to step 308, where the source node 110 allocates the message for beacon transmission. At step 310, the source node 110 computes a sum of the lengths of a first beacon and the message. At step 312, the source node compares the sum of the lengths exceeds some threshold T2, where T2 represents the maximum desired size of the beacon. If the sum does not exceed T2, then the method proceeds to step 314, where the message is assigned to the first beacon. In this case, the source node has determined that there is sufficient space in the first beacon for the message. The method 300 then terminates. Returning to step 312, if the sum exceeds T2, then the method proceeds to step 316, where the message is assigned to a second beacon. In this case, the source node 110 has determined that there is insufficient space in the first beacon for the message, and therefore allocates the message to a second beacon which does have sufficient space. The method then terminates.

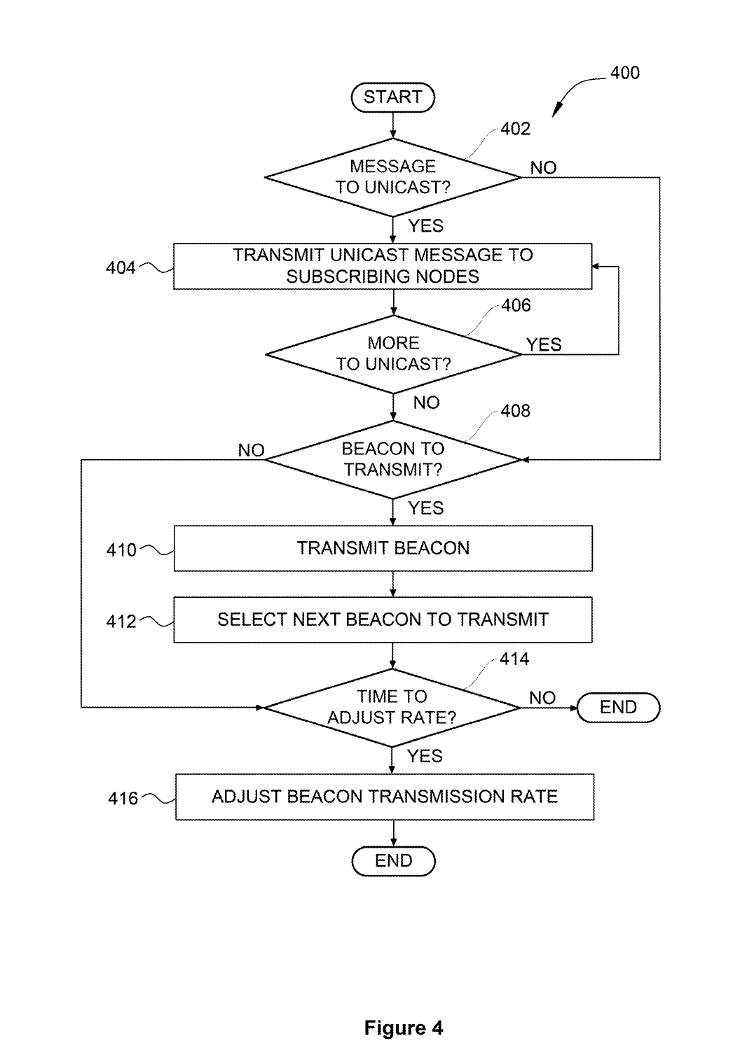

FIG. 4 is a flow diagram of method steps 400 for transmitting beacon and unicast traffic within a network system, according to one embodiment of the present invention. Although the method steps 400 are described in conjunction with the systems of FIGS. 1-2, persons of ordinary skill in the art will understand that any system configured to perform the method steps 400, in any order, is within the scope of the present invention.

The method 400 begins at step 402, where the source node 110 determines whether there is at least one message to transmit in unicast mode. If there is a message to transmit in unicast mode, then the method proceeds to step 404, where the source node 110 transmits the unicast message separately to each of the nodes which have subscribed to the message. At step 406, the source node determines whether there are additional messages to transmit in unicast mode. If there are additional messages to transmit in unicast mode, then the method 400 returns to step 404 where the source node 110 transmits the next unicast message separately to each of the nodes which have subscribed to the message. If there are no additional messages to transmit in unicast mode, then the method proceeds to step 408, where the source node 110 determines whether there is a beacon to transmit, where the beacon contains one or more messages to send to all neighboring nodes. If there is a beacon to transmit, then the method proceeds to step 410, where the source node 110 transmits the beacon. At step 412, the source node selects the next beacon to be transmitted during the next transmission period. If the source node 110 currently has more than one beacon, then the source node 110 selects a different beacon than the one just transmitted using, for example, a round-robin approach. At step 414, the source node determines whether a timer has expired indicating that the beacon transmission rate may be adjusted. The source node 110 may choose a minimum time period during which the beacon transmission rate does not change. If this minimum time period has expired, then the source node determines that the beacon transmission rate may be adjusted. The method proceeds to step 418, where the source node 110 adjusts the beacon transmission rate. The source node 110 may adjust the beacon transmission rate under specific conditions, such as when the number of beacons to transmit has increased or decreased. The method then terminates. Returning to step 414, if the beacon transmission rate may not be adjusted at the present time, then the method terminates. Returning to step 408, if there is no beacon to transmit, then the method 400 proceeds to step 414 and continues as set forth above. Returning to step 402, if there is no message to transmit in unicast mode, then the method 400 proceeds to step 408 and continues as set forth above.

In sum, the disclosed technique provides an improved way for a source node 110 to manage beacon traffic. Specifically, the source node 110 determines that a new message is to be transmitted to one or more neighboring nodes 130. The source node 110 assigns a value to the message based on the type of message, the size of the message, and the number of neighboring nodes 130 that wish to subscribe to the message. The source node 110 utilizes this message value to determine whether to unicast the message to each one of the subscribing nodes 130 or to add the message to the source node's 110 beacon. If adding the message to the source node's 110 beacon results in a beacon length that is above a desired limit, then the source node 110 may add a second beacon to carry the new message. When the source node 110 maintains multiple beacons, the source node 110 may transmit the beacons one at a time in a round-robin approach. The source node 110 may also adjust the beacon transmission rate based on the number of beacons in the round-robin sequence. A particular message may be added to or removed from a beacon as the number of subscribing nodes 130 increases or decreases respectively. Moreover, the source node 110 may rebuild beacons and unicast messages at regular intervals in order to maintain efficient message transmission to neighboring nodes 130.

Advantageously, beacon transmission times are kept low in order to reduce the likelihood that the beacon encounters interference from artificial or natural sources, including interference from beacons transmitted by other nodes 130. Messages are allocated to a beacon or scheduled for unicast transmission based on whether beaconing or unicast transmission would be more efficient. Nodes 110, 112, 130 flexibly manage beacons and unicast messages for efficient transmission under varying mixes of message types and sizes. The result is an increased probability that beacons are successfully received and a decrease in overall network traffic.

While the foregoing is directed to embodiments of the present invention, other and further embodiments of the invention may be devised without departing from the basic scope thereof. For example, aspects of the present invention may be implemented in hardware or software or in a combination of hardware and software. One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored. Such computer-readable storage media, when carrying computer-readable instructions that direct the functions of the present invention, are embodiments of the present invention.

In view of the foregoing, the scope of the present invention is determined by the claims that follow.

What is claimed is:

1. A computer-implemented method for managing beacon traffic within a network system, the method comprising:
identifying a message to be transmitted to at least one neighboring node;
computing a message value related to one or more characteristics associated with the message;
determining a mode in which to transmit the message based on the message value; and
transmitting the message in a beacon mode if the message value exceeds a first threshold; or
transmitting the message in a unicast mode if the message value does not exceed the first threshold.

2. The method of claim 1, wherein transmitting the message in a beacon mode comprises allocating the message to a first beacon if a sum of a length of the first beacon and a length of the message does not exceed a second threshold.

3. The method of claim 2, wherein transmitting the message in the beacon mode comprises allocating the message to a second beacon if the sum of the length of the first beacon and the length of the message exceeds the second threshold.

4. The method of claim 3, further comprising adjusting a beacon transmission rate based on the number of beacons being transmitted.

5. The method of claim 1, wherein the message comprises a routing advertisement.

6. The method of claim 1, wherein the message value corresponds to the number of nodes requesting to subscribe to a service associated with the message.

7. The method of claim 1, wherein the message value corresponds to a length of the message.

8. The method of claim 1, wherein the message value corresponds to a message type associated with the message.

9. A computer-readable medium including instructions that, when executed by a processing unit, cause the processing unit to manage beacon traffic within a network system, by performing the steps of:
identifying a message to be transmitted to at least one neighboring node;
computing a message value related to one or more characteristics associated with the message;
determining a mode in which to transmit the message based on the message value; and
transmitting the message in a beacon mode if the message value exceeds a first threshold; or
transmitting the message in a unicast mode if the message value does not exceed the first threshold.

10. The computer-readable medium of claim 9, wherein transmitting the message in a beacon mode comprises allocating the message to a first beacon if a sum of a length of the first beacon and a length of the message does not exceed a second threshold.

11. The computer-readable medium of claim 10, wherein transmitting the message in the beacon mode comprises allocating the message to a second beacon if the sum of the length of the first beacon and the length of the message exceeds the second threshold.

12. The computer-readable medium of claim 11, further comprising adjusting a beacon transmission rate based on the number of beacons being transmitted.

13. The computer-readable medium of claim 9, wherein the message comprises a routing advertisement.

14. The computer-readable medium of claim 9, wherein the message value corresponds to the number of nodes requesting to subscribe to a service associated with the message.

15. The computer-readable medium of claim 9, wherein the message value corresponds to a length of the message.

16. The computer-readable medium of claim 9, wherein the message value corresponds to a message type associated with the message.

17. A computing device comprising:
a processing unit configured to manage beacon traffic within a network system, by performing the steps of:
identifying a message to be transmitted to at least one neighboring node;
computing a message value related to one or more characteristics associated with the message;
determining a mode in which to transmit the message based on the message value; and
transmitting the message in a beacon mode if the message value exceeds a first threshold; or
transmitting the message in a unicast mode if the message value does not exceed the first threshold.

18. The computing device of claim 17, wherein transmitting the message in a beacon mode comprises allocating the message to a first beacon if a sum of a length of the first beacon and a length of the message does not exceed a second threshold.

19. The computing device of claim 18, wherein transmitting the message in the beacon mode comprises allocating the message to a second beacon if the sum of the length of the first beacon and the length of the message exceeds the second threshold

20. The computing device of claim 17, wherein the message comprises a routing advertisement.
